(19) United States
(12) Patent Application Publication
(10) Pub. No.: US 2025/0198450 A1
(43) Pub. Date: Jun. 19, 2025

(54) DIRECTIONAL WASHER AND METHOD OF USE

(71) Applicant: The Boeing Company, Arlington, VA (US)

(72) Inventors: Mark Albrecht, Lake Stevens, WA (US); Jeffry Bickford, Federal Way, WA (US); Kwok Tung Chan, Seattle, WA (US); Tuan Ly, Kent, WA (US); Sean Morden, Federal Way, WA (US)

(21) Appl. No.: 18/389,596

(22) Filed: Dec. 19, 2023

(51) Int. Cl. F16B 43/00

(52) U.S. Cl. CPC F16B 43/001; F16B 2200/95

(57) ABSTRACT

Aa directional washer has a washer body, a direction-dependent element, and a direction indicator. The washer body has a washer body first surface, a washer body second surface, and a washer body radially outer surface. The direction-dependent element is associated with the washer body and has a geometry configured complementary to the head or nut of a fastener when the washer body first surface is in contact respectively with the head engagement surface of the head or the nut engagement surface of the nut. The direction indicator is formed on the washer body radially outer surface and/or on the peripheral portion of the washer body first surface, and is configured to identify the washer body first surface for differentiation from the washer body second surface.

### FIELD

The present disclosure relates generally to fastener systems and, more particularly, to a directional washer having a means for determining its orientation on a fastener.

### BACKGROUND

Washers are commonly used in fastener installations for a variety of reasons. For example, a washer is typically installed on the shank of a bolt to provide a bearing surface for the nut as it is tightened or torqued onto the threaded portion of the shank. The washer prevents the rotating nut from scoring the underlying structure during the torquing process. In addition, washers can reduce the risk of galvanic corrosion which can occur due to the interaction of dissimilar materials, such as a metallic (e.g., steel) nut/bolt and a composite (e.g., graphite-epoxy) structure.

Seal washers are a type of washer used in applications where protection from electromagnetic effects (EME) and hot particle ejection (HPE) is required. For example, seal washers are used in aircraft as protection against EME and HPE during a lightning strike. Electrical current generated during a lightning strike is conducted through metallic fasteners and into the structure of the aircraft. The flow of electrical current causes localized heating of the materials of the fasteners and structure, which can result in the generation of hot gas or plasma within voids in and around a fastener installation. For example, hot gas can be generated within voids between the nut and shank of a bolt, which can result in hot particle ejection (i.e., HPE) from the fastener installation when pressures within the voids become high enough.

To mitigate or prevent HPE, seal washers have a polymeric seal that axially protrudes from one side of the washer body. The polymeric seal is configured to fill the void between the nut and shank of a bolt. By filling the void, the polymeric seal prevents the generation of hot gas that can otherwise lead to HPE. In addition, the polymeric seal provides protection against other potential EME during a lightning strike.

To ensure their effectiveness, seal washers must be installed in the correct orientation on a fastener. In this regard, the seal washer is a directional washer in the sense that it must be installed such that the polymeric seal extends into a counterbore in the nut. If the seal washer is installed incorrectly, the polymeric seal will not properly fill the counterbore when the nut is tightened, compromising the ability of the seal washer to protect against HPE. Unfortunately, once the nut is fully installed on the bolt, the polymeric seal is not visible, such that it is not possible to determine whether the seal washer is installed correctly.

As can be seen, there exists a need in the art for a system and method for determining the orientation of a directional washer such as a seal washer, such as after installation on a fastener.

### SUMMARY

The above-noted needs associated with directional washers are addressed by the present disclosure, which provides a directional washer having a washer body, a direction-dependent element, and a direction indicator. The washer body has a washer body first surface, a washer body second surface, and a washer body radially outer surface. The direction-dependent element is associated with the washer body and has a geometry configured complementary to the head or nut of a fastener when the washer body first surface is in contact respectively with the head engagement surface of the head or the nut engagement surface of the nut. The direction indicator is formed on the washer body radially outer surface and/or on the peripheral portion of the washer body first surface, and is configured to identify the washer body first surface for differentiation from the washer body second surface.

Also disclosed is a fastener system comprising a fastener and a directional washer. The fastener has a head and a shank which is insertable into a fastener hole in a structure. The directional washer is mountable on the fastener, and comprises a washer body, and a direction-dependent element associated with the washer body. The direction-dependent element associated with the washer body has a washer body first surface, a washer body second surface, and a washer body radially outer surface. The direction-dependent element is configured complementary to the head or the nut of the fastener when the washer body first surface is in contact respectively with the head engagement surface of the head or the nut engagement surface of the nut. The direction indicator is formed on the washer body radially outer surface and/or on the peripheral portion of the washer body first surface at a location that is visible when the fastener is installed in the fastener hole. The direction indicator is configured to identify the washer body first surface for differentiation from the washer body second surface.

Also disclosed is a method of determining the orientation of a directional washer. The method includes inspecting a direction indicator formed on the washer body radially outer surface and/or on the peripheral portion of the washer body first surface. The direction indicator is configured to indicate the washer body first surface for differentiation from a washer body second surface. The directional washer has a direction-dependent element configured complementary to the geometry of the head or the nut of a fastener when the washer body first surface is in contact respectively with one of a head engagement surface of the head or a nut engagement surface of the nut.

The features, functions, and advantages that have been discussed can be achieved independently in various versions of the disclosure or may be combined in yet other versions, further details of which can be seen with reference to the following description and drawings.

### BRIEF DESCRIPTION OF THE DRAWINGS

The disclosure can be better understood with reference to the following detailed description taken in conjunction with the accompanying drawings, which illustrate preferred and exemplary versions, but which are not necessarily drawn to scale. The drawings are examples and not meant as limitations on the description or the claims.

FIG. 1 shows an example of a fastener installation comprising a bolt having a countersunk head and installed in a fastener hole, and further illustrating a directional washer and a nut secured to a threaded portion of a shank of the bolt;

FIG. 2 is a partially exploded sectional view of the fastener installation of FIG. 1 showing the directional washer configured as a seal washer having a polymeric seal extending axially from the washer body first surface in a direction toward the nut;

FIG. 3 is a perspective view of an example of the seal washer of FIG. 2 showing a plurality of direction indicators configured as protrusions extending from a washer body first surface;

FIG. 4 is a sectional view of the fastener installation of FIG. 1 illustrating the polymeric seal filling a void between the nut and the fastener;

FIG. 5 is a magnified view of the portion of FIG. 4 identified by reference numeral 5, and illustrating the void between the nut and the fastener, and further illustrating a protrusion (i.e., a direction indicator) protruding from the washer body first surface;

FIG. 6 is a perspective sectional view of the seal washer of FIG. 3 having a plurality of direction indicators configured as protrusions;

FIG. 7 is a sectional view of the seal washer of FIG. 6;

FIG. 8 is a perspective view of an example of a seal washer having direction indicators configured as depressions;

FIG. 9 is a sectional view of the seal washer of FIG. 8;

FIG. 10 is a perspective view of an example of a seal washer in which the direction indicator is configured as a circumferential chamfer;

FIG. 11 is a sectional view of the seal washer of FIG. 10;

FIG. 12 is a partial sectional view of a seal washer in which the direction indicator is configured as a circumferential radius;

FIG. 13 is a perspective view of an example of the seal washer in which the direction indicator is configured as a circumferential groove;

FIG. 14 is a sectional view of the seal washer of FIG. 13 in which the circumferential groove has an orthogonal cross-sectional shape;

FIG. 15 is a partial sectional view of a seal washer in which the circumferential groove has a semicircular cross-sectional shape;

FIG. 16 is a partial sectional view of a seal washer in which the circumferential groove has a triangular cross-sectional shape;

FIG. 17 is a perspective view of an example of a seal washer in which the direction indicator comprises color coding in the form of a first color on the washer body first surface and a second color on a washer body radially outer surface;

FIG. 18 is a perspective view of an example of a seal washer in which the direction indicator comprises indicia in the form of arrows pointing toward the side of the washer body configured to face the nut;

FIG. 19 is a perspective view of an example of a seal washer in which the direction indicator comprises indicia in the form of reference characters identifying the side of the washer body configured to face the nut;

FIG. 20 is a perspective view of an example of a seal washer in which the direction indicator comprises indicia in the form of a barcode on the washer body first surface;

FIG. 21 shows an example of a fastener installation comprising a hex-headed bolt installed in a fastener hole, and having a directional washer having a washer countersink installed between the head of the bolt and the underlying structure;

FIG. 22 is a top view of the directional washer of FIG. 21 illustrating a plurality of direction indicators in the form of protrusions extending from the washer body first surface;

FIG. 23 is a sectional view of the fastener of FIG. 21 illustrating an inside radius between the shank and the head of the bolt, and further illustrating a washer countersink when the directional washer four for accommodating the inside radius of the bolt;

FIG. 24 is a perspective view of the directional washer of FIG. 22 showing the washer countersink, and further illustrating the direction indicators in the form of protrusions extending from the washer body first surface;

FIG. 25 is a flowchart of an operation included in a method of determining an orientation of a directional washer on a fastener installation by inspecting one or more direction indicators on the washer body;

FIG. 26 shows an example of an imaging device mounted to a robotic arm for capturing images of a fastener installations in a structure for determining the orientation of the directional washers on the fasteners;

FIG. 27 shows an example of an automated fastener installation system supported by robotic arms on opposite sides of a structure for automated fastener installation into the structure, and further illustrating imaging devices mounted to the automated fastener installation system for inspecting the fastener installations to determine the orientation of the directional washers before and/or after installation.

The figures shown in this disclosure represent various aspects of the versions presented, and only differences will be discussed in detail.

### DETAILED DESCRIPTION

Disclosed versions will now be described more fully hereinafter with reference to the accompanying drawings, in which some, but not all of the disclosed versions are shown. Indeed, several different versions may be provided and should not be construed as limited to the versions set forth herein. Rather, these versions are provided so that this disclosure will be thorough and fully convey the scope of the disclosure to those skilled in the art.

This specification includes references to “one version” or “a version.” Instances of the phrases “one version” or “a version” do not necessarily refer to the same version. Similarly, this specification includes references to “one example” or “an example.” Instances of the phrases “one example” or “an example” do not necessarily refer to the same example. Particular features, structures, or characteristics may be combined in any suitable manner consistent with this disclosure.

As used herein, “comprising” is an open-ended term, and as used in the claims, this term does not foreclose additional structures or steps.

As used herein, “configured to” means various parts or components may be described or claimed as “configured to” perform a task or tasks. In such contexts, “configured to” is used to connote structure by indicating that the parts or components include structure that performs those task or tasks during operation. As such, the parts or components can be said to be configured to perform the task even when the specified part or component is not currently operational (e.g., is not on).

As used herein, an element or step recited in the singular and preceded by the word “a” or “an” should be understood as not necessarily excluding the plural of the elements or steps. As used herein, the term “and/or” includes any and all combinations of one or more of the associated listed items. As also used herein, the term “combinations thereof” includes combinations having at least one of the associated listed items, wherein the combination can further include additional, like non-listed items.

As used herein, the phrase “at least one of,” when used with a list of items, means different combinations of one or more of the listed items may be used, and only one of each item in the list may be needed. In other words, “at least one of” means any combination of items and number of items may be used from the list, but not all of the items in the list are required. The item may be a particular object, a thing, or a category.

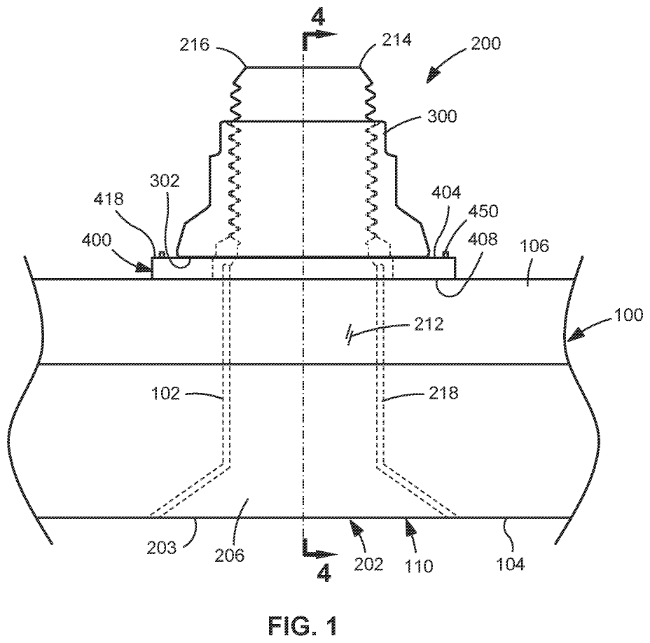

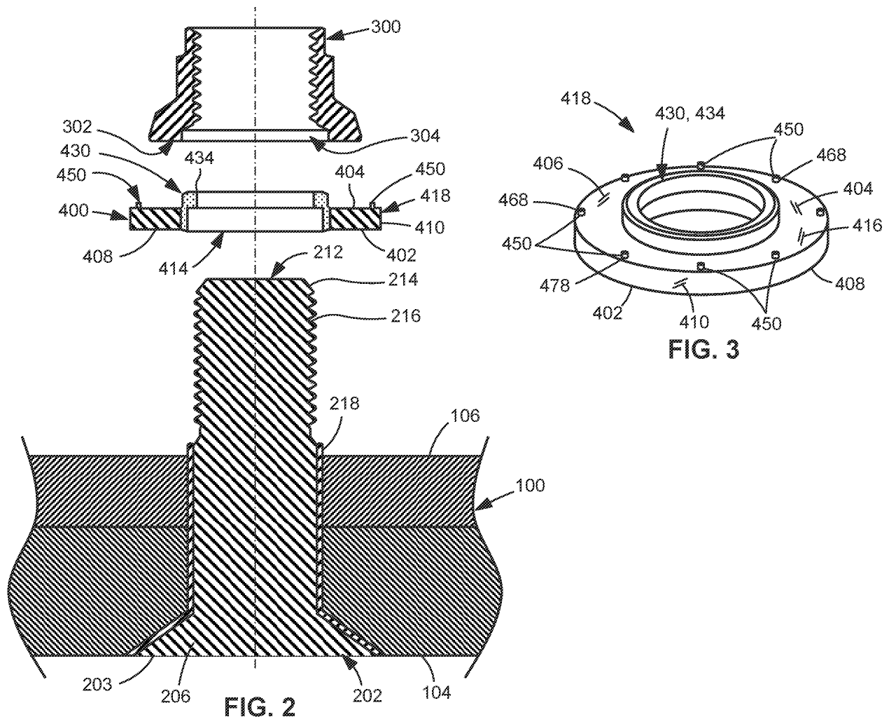

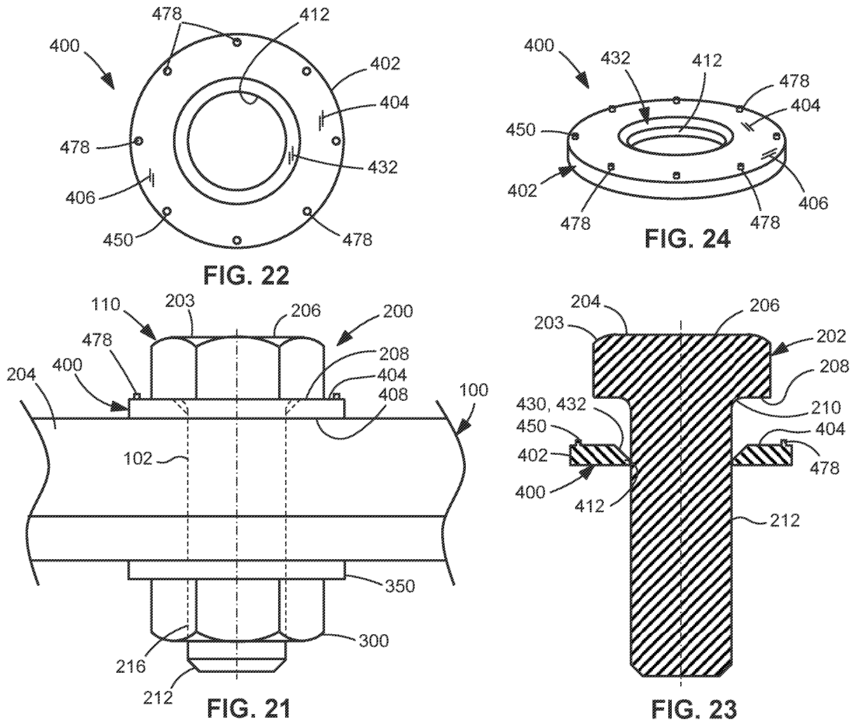

Referring now to the drawings which illustrate various examples of the disclosure, shown in FIGS. 1-2 is an example of a fastener system 200 installed in a fastener hole 102 formed in a structure 100. The fastener system 200 comprises a sleeved fastener having a sleeve 218 and a bolt 203 inserted through the sleeve 218. The bolt 203 has a head 206 and a shank 212. The free end of the shank 212 has a threaded portion 216 which is shown protruding from a back side 106 of the structure 100. In the example shown, the fastener 202 is a flush-head fastener having a countersunk head. However, in other examples not shown, the bolt 203 can have a standard hex head and/or the sleeve 218 can be omitted from the fastener system 200 as shown in the example of FIG. 21 described below. Furthermore, the fastener 202 can be provided in any one of a variety of configurations, and is not limited to a bolt 203. For example, the fastener 202 can be a screw, a Hi-Lok™, a Hi-Lite™, a Lok-Bolt™, or any one of a variety of other types of fasteners 202. The nut 300 can be any type of threaded receptable, and is not limited to a hex nut.

In the example of FIGS. 1-5, the fastener system 200 includes a nut 300 threadably engaged to the threaded portion 216 of the shank 212. The fastener system 200 also includes the presently-disclosed directional washer 400 which, in the example shown, is configured as a seal washer 418 installed on a tail side 214 of the bolt 203 and captured between the nut 300 and the underlying structure 100. In other fastener systems 200, the directional washer 400 can be provided in configurations other than a seal washer 418. Furthermore, the directional washer 400 can be installed on a front side 104 of the structure 100 between the head 206 and the underlying structure 100 as shown in the example of FIG. 21, and is not limited to being installed on the tail side 214 of the fastener 202.

Regardless of the configuration of the fastener system 200, the sleeve 218, bolt 203, and nut 300 are typically formed of metallic material such as steel, stainless steel, nickel, titanium, or any one of a variety of other metallic materials. The structure 100 is comprised of two or more components which are fastened together via the fastener system 200. The components of the structure 100 can be formed of any material such as metallic material and/or composite material. For example, each of the components of the structure 100 can be formed as composite laminates comprised of multiple plies of fiber-reinforced polymer matrix material (e.g., graphite-epoxy).

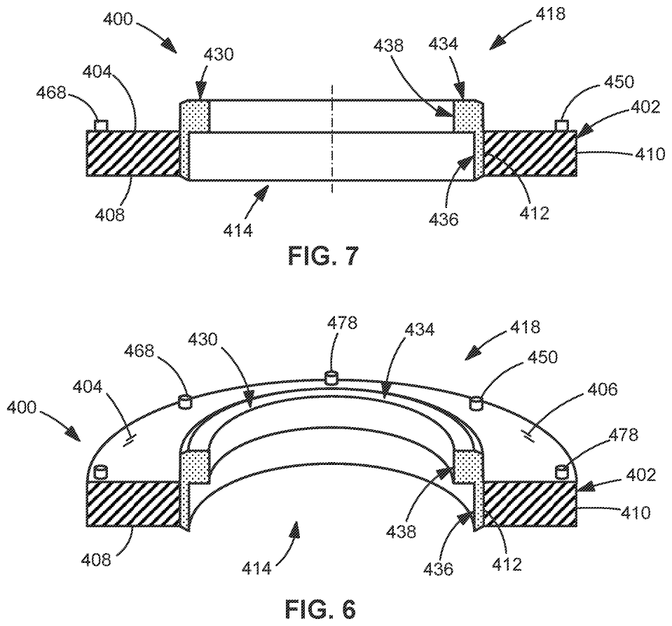

Referring to FIGS. 1-7, the seal washer 418 (i.e., the directional washer 400) has a washer body 402, a direction-dependent element 430, and a direction indicator 450. The washer body 402 is formed of a metallic material and is generally flat and has a ring shape. The washer body 402 has a washer body first surface 404 and a washer body second surface 408 opposite the washer body first surface 404. In addition, the washer body 402 has a washer body radially outer surface 410 and a washer body radially inner surface 412. The washer body radially inner surface 412 defines a washer opening 414 configured to receive a shank 212 of a fastener 202.

In any one of the directional washer 400 examples disclosed herein, the metallic component (e.g., the washer body 402) can include a dielectric coating 416 configured to limit galvanic corrosion and/or electrical continuity between the fastener 202 and the structure 100. For example, the washer body 402 of the seal washer 418 described below can include a dielectric coating 416 (FIG. 3) on the washer body first surface 404, the washer body second surface 408, the washer body radially outer surface 410, and the washer body radially inner surface 412.

In the present disclosure, when a directional washer 400 is installed on a fastener 202, the washer body first surface 404 faces away from the structure 100, and the washer body second surface 408 faces toward the structure 100. The washer body first surface 404 is configured to be in contact with a head engagement surface 208 (FIG. 21) on the underside of a head 206 (FIG. 21) of a fastener 202 (FIG. 21), or the washer body first surface 404 is configured to be in contact with a nut engagement surface 302 (FIG. 2) on the underside of a nut 300. The washer body second surface 408 (FIG. 2) is configured to be in contact with the structure 100 into which the fastener 202 is inserted. For example, in the fastener installation of FIGS. 1-7, the washer body first surface 404 faces toward the nut 300 and is in contact with the nut engagement surface 302, and the washer body second surface 408 faces toward the structure 100 and is in contact with the structure 100. In the fastener installation of FIGS. 21-24, the washer body first surface 404 faces toward the head 206 and is in contact with the head engagement surface 208, and the washer body second surface 408 faces toward the structure 100 and is in contact with the structure 100.

Referring to FIGS. 1-7, the washer body 402 has a direction-dependent element 430 which can be described as a non-uniform geometry that differs from the basic geometry of the washer body 402. The geometry of the direction-dependent element 430 is complementary to the geometry of the head 206 or nut 300 of a fastener 202 onto which the directional washer 400 is installed. For fastener installations in which the directional washer 400 is installed on the front side 104 of the structure 100 such that the washer body first surface 404 is in contact with the head engagement surface 208 of the head 206 of the fastener 202, the direction-dependent element 430 is at least partially hidden from view by the head 206 as shown in FIGS. 21-24. For fastener installations in which the directional washer 400 is installed on the tail side 214 of a fastener 202 such that the washer body first surface 404 is in contact with the nut engagement surface 302 of a nut 300, the direction-dependent element 430 is at least partially hidden from view by the nut 300 as shown in FIGS. 1-4.

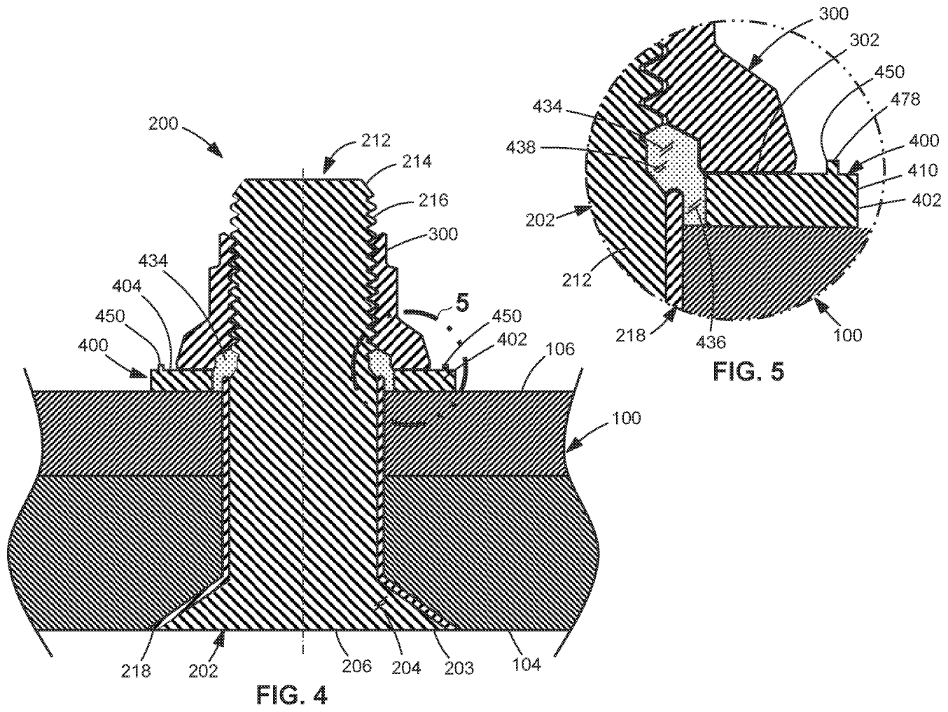

In FIGS. 1-20, the direction-dependent element 430 of the seal washer 418 is a polymeric seal 434 formed of an electrically non-conductive material. For example, the polymeric seal 434 can be formed of a thermoplastic material such as polyetheretherketone (PEEK), or any other electrically non-conductive elastomeric material. The polymeric seal 434 has one or more seal portions extending axially from the washer body first surface 404 and/or the washer body second surface 408. For example, as shown in FIGS. 2-7, the polymeric seal 434 has a seal first portion 436 and a seal second portion 438. The seal first portion 436 is coextensive with the washer body 402 and is directly coupled to the washer body radially inner surface 412. The seal first portion 436 is configured to seal around the shank 212 of the fastener 202 and prevent contact between the washer body 402 and the shank 212 (or sleeve 218) when the nut 300 is secured or torqued on the threaded portion 216 of the fastener 202 as shown in FIGS. 4-5.

Referring still to FIGS. 2-7, the seal second portion 438 extends axially from the seal first portion 436 in a direction away from the washer body first surface 404. The seal second portion 438 has a geometry that is complementary to the geometry of a nut counterbore 304 (FIG. 2) of the nut 300, and is configured to fill the void otherwise occurring between the nut counterbore 304 and the shank 212 when the nut 300 is secured on the fastener 202 as shown in FIGS. 4-5. By filling the void between the nut 300 and fastener 202, the polymeric seal 434 prevents the generation of hot gas that can otherwise lead to HPE, as mentioned above. In addition, the polymeric seal 434 provides protection against other EME during a lightning strike.

As mentioned above, the seal washer 418 (i.e., the directional washer 400) has a direction indicator 450 formed on the washer body radially outer surface 410 and/or on a peripheral portion 406 of the washer body first surface 404. The direction indicator 450 is formed on the washer body 402 at a location that is visible when the directional washer 400 is mounted on a fastener 202 and the washer body first surface 404 is in contact with the head engagement surface 208 of the head 206 of the fastener 202 (e.g., FIGS. 21-24) or when the washer body first surface 404 is in contact with the nut engagement surface 302 of a nut 300 (e.g., FIGS. 1-20). The direction indicator 450 is configured to facilitate the identification of the washer body first surface 404 for differentiation from the washer body second surface 408 of a directional washer 400 installed on a fastener 202. In this regard, the direction indicator 450 provides a means for determining whether the directional washer 400 is oriented correctly on the fastener 202, and thereby facilitates inspection of the fastener installation.

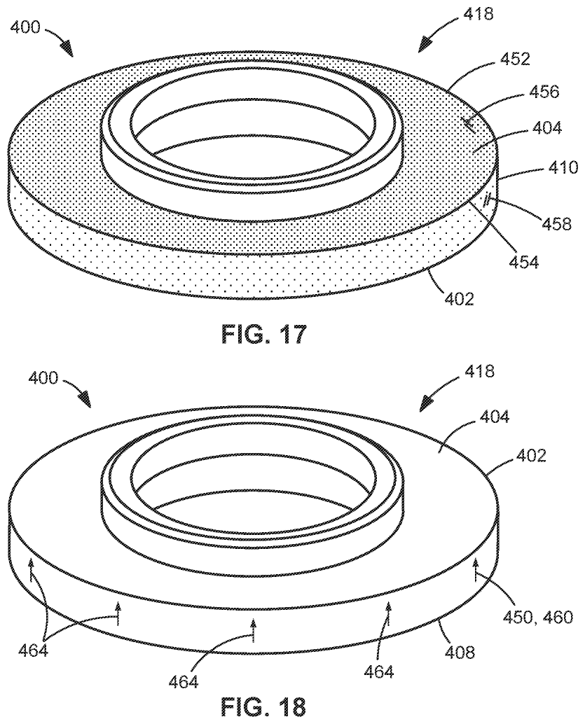

The direction indicator 450 can be provided as one or more geometric elements 468 as shown in FIGS. 1-16. In the present disclosure, a geometric element 468 can be described as a geometric discontinuity in the washer body radially outer surface 410 and/or the washer body first surface 404. As an alternative to or in addition to geometric elements 468, the direction indicator 450 can be provided as one or more markings 452 as shown in FIGS. 17-20.

Referring to FIGS. 1-6, shown is an example of a directional washer 400 (i.e., a seal washer 418) in which the geometric elements 468 are protrusions 478 extending outwardly from the washer body first surface 404. In the example shown, the protrusions 478 comprise a plurality of cylindrical posts angularly spaced apart from each other and positioned at a location on the peripheral portion 406 that is visible when the nut engagement surface 302 of a nut 300 or a head engagement surface 208 of the head 206 (e.g., FIG. 21) is in contact with the washer body first surface 404. The cylindrical posts may be relatively small. For example, each cylindrical post may have a diameter of less than 0.10 inch and a height of less than 0.10 inch. However, the cylindrical posts may be provided in any size. In other examples not shown, the protrusions 478 may be configured as rounded bumps or other protruding geometric elements 468. The washer body 402 can alternatively or additionally include protrusions 478 (not shown) that extend outwardly from the washer body radially outer surface 410 and which are located proximate the washer body first surface 404.

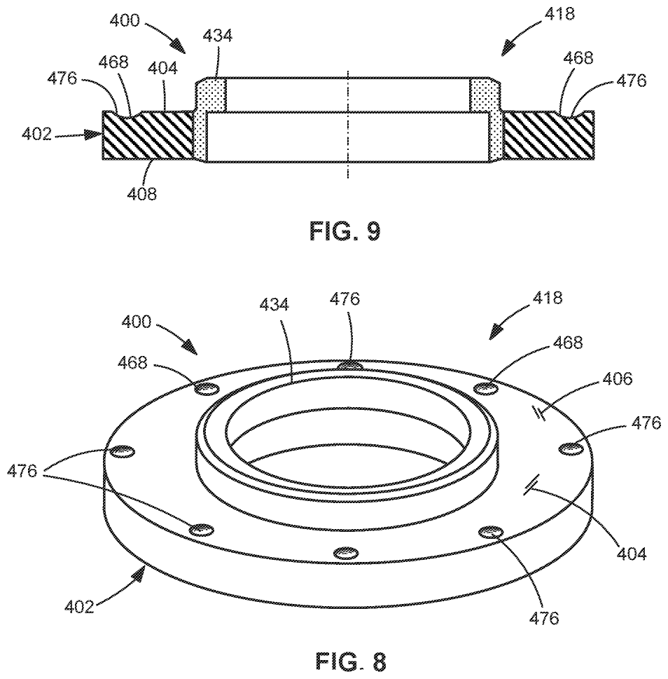

Referring to FIGS. 8-9, shown is an example of a directional washer 400 (i.e., a seal washer 418) in which the geometric elements 468 are depressions 476 formed in the washer body first surface 404. In the example shown, the depressions 476 are circularly-shaped dimples that are spaced apart from each other along the peripheral portion 406 of the washer body first surface 404 at a location that is visible when a nut engagement surface 302 of a nut 300 or a head engagement surface 208 is in contact with the washer body first surface 404. Similar to the above-described cylindrical posts, each dimple can be relatively small in size, and may have a diameter of less than 0.10 inch. Alternatively or additionally, the depressions 476 or dimples can be formed along the washer body radially outer surface 410 proximate the washer body first surface 404. Similar to protrusions 478, the depressions 476 provide a means for differentiating the washer body first surface 404 from the washer body second surface 408.

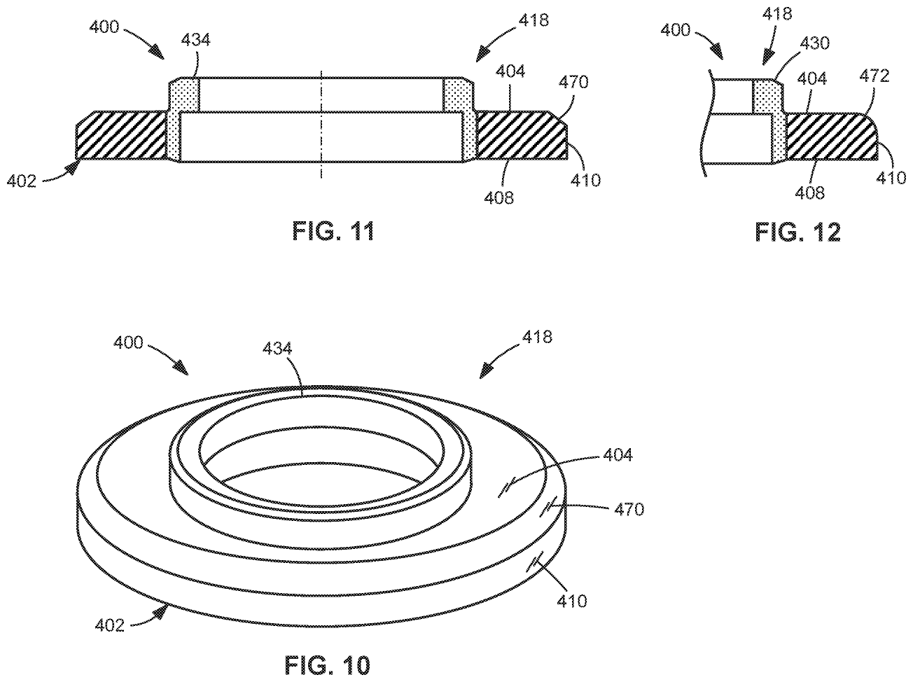

Referring to FIGS. 10-16, shown is an example of a directional washer 400 (i.e., a seal washer 418) in which the geometric element 468 comprises the modification of the cross-sectional profile of the washer body 402. For example, FIGS. 10-11 show a circumferential chamfer 470 at the juncture of the washer body first surface 404 with the washer body radially outer surface 410. FIG. 12 shows an example of a directional washer 400 in which the geometric element 468 is a circumferential radius 472 formed at the juncture of the washer body first surface 404 with the washer body 402 outer surface. The circumferential chamfer 470, the circumferential radius 472, and any of the other geometric elements 468 described herein are preferably large enough to be detectable with the unaided eye at a distance of up to several feet. Alternatively or additionally, any of the geometric elements 468 described herein are preferably large enough to be detectable via touch with a human finger or fingernail.

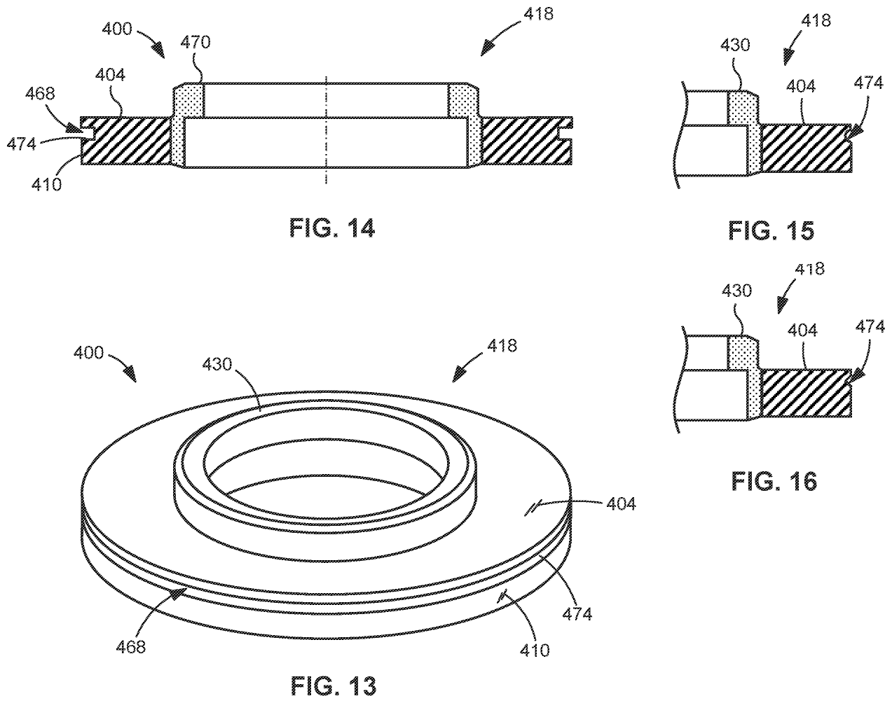

FIGS. 13-16 show an example of a directional washer 400 (i.e., a seal washer 418) in which the geometric element 468 comprises a circumferential groove 474 formed in the washer body radially outer surface 410. Alternatively or additionally, a washer body 402 may include one or more circumferential grooves 474 formed on the peripheral portion 406 of the washer body first surface 404. FIGS. 13-14 show a single circumferential groove 474 having an orthogonal cross-sectional shape formed in the washer body radially outer surface 410. However, the washer body 402 can include multiple grooves (not shown) or groove segments (not shown) formed in the washer body radially outer surface 410 and/or in the washer body first surface 404. FIG. 15 shows an example of a circumferential groove 474 having a semicircular cross-sectional shape. FIG. 16 shows an example of a circumferential groove 474 having a triangular cross-sectional shape. As may be appreciated, a circumferential groove 474 can be provided in any one of a variety of cross-sectional shapes.

Referring to FIGS. 17-20, shown are examples of directional washers 400 (i.e., seal washers 418) in which the direction indicator 450 comprises one or more markings 452 on the washer body 402. Any of the marking 452 examples described below can be comprised of ink, paint, laser marking, electrochemical etching, or any one of a variety of materials by which markings 452 can be applied the washer body 402 for identifying the washer body first surface 404.

FIG. 17 shows an example of a marking 452 in the form of a color code 454 on the washer body 402 to distinguish the washer body first surface 404 from the washer body second surface 408. The color code 454 comprises a first color 456 on the washer body first surface 404, and the first color 456 is different than a second color 458 applied to the washer body radially outer surface 410. The first color 456 and the second color 458 are visible when the washer body first surface 404 is in contact with a nut engagement surface 302 of a nut 300 or a head engagement surface 208 of a fastener head 206.

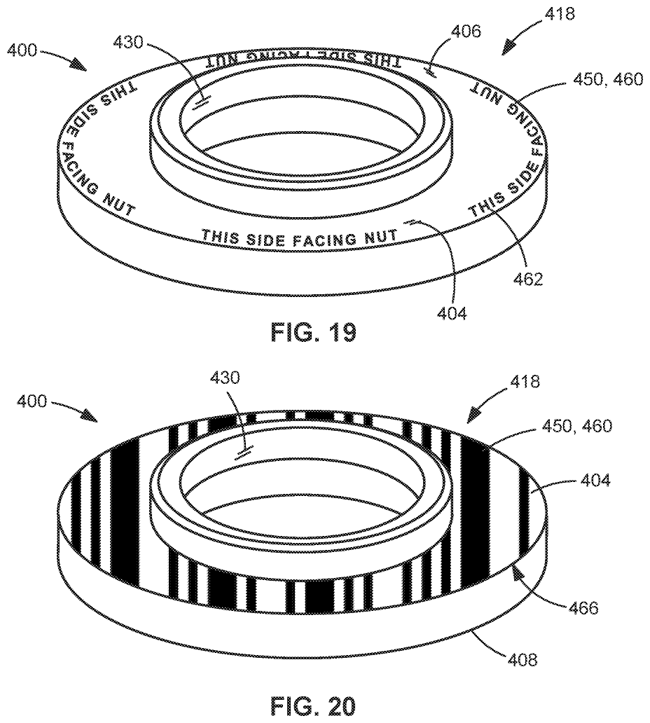

FIGS. 18-20 show examples of directional washers 400 (i.e., seal washers 418) in which the direction indicator 450 comprises indicia 460 applied to the washer body 402 in a manner identifying the washer body first surface 404. The indicia 460 can include reference characters 462, symbols 464, a barcode 466, or any one of a variety of other types of indicia 460 for distinguishing the washer body first surface 404 from the washer body second surface 408. For example, FIG. 18 shows an example of symbols 464 in the form of arrows pointing toward the washer body first surface 404. FIG. 19 shows an example of reference characters 462 in the form of labels (e.g., “This Side Facing Nut”) applied to the peripheral portion 406 of the washer body first surface 404.

FIG. 20 shows an example of a barcode 466 applied to the washer body first surface 404. In addition to distinguishing the washer body first surface 404 from the washer body second surface 408, the barcode 466 can contain the manufacturer's identification number and/or the barcode 466 can include information such as washer configuration, size (e.g., thickness, inner diameter, outer diameter), material of the washer body 402, material of the polymeric seal 434, manufacturing date, lot number, and any one of a variety of other types of information. The barcode 466 can be scanned by a barcode reader (not shown) which can capture an image of the barcode 466 and translate the barcode 466 into numbers and/or letters that are sent to a processor (not shown) for translation into the manufacturer's identification number or other data.

Referring to FIGS. 21-24, shown is an example of a fastener installation (i.e., a fastener system 200) comprising a hex-headed bolt 203 installed in a fastener hole 102 of a structure 100. The front side 104 of the structure 100 includes a directional washer 400 captured between the head 206 of the bolt 203 and the underlying structure 100. The back side 106 of the structure 100 includes a conventional washer 350 (i.e., a non-directional washer) captured between the nut 300 and the underlying structure 100. The washer body 402 has a washer countersink 432 formed in the washer opening 414. The washer countersink 432 may be described as an inner chamfer formed along the juncture of the washer body first surface 404 and the washer body radially inner surface 412. The washer countersink 432 is configured complementary to an inside radius 210 (FIG. 23) formed along the juncture of the head engagement surface 208 and the shank 212. The inside radius 210 allows the head engagement surface 208 to sit flush against the washer body 402.

Also shown in FIGS. 21-24 are a plurality of direction indicators 450 in the form of protrusions 478 extending outwardly from the washer body first surface 404 and located at spaced intervals along the peripheral portion 406. In the example shown, the protrusions 478 are configured similar to the protrusions 478 on the above-described seal washer 418 of FIGS. 1-8, and provide a means for identifying the washer body first surface 404 for differentiation from the washer body second surface 408. Although shown having protrusions 478, the washer body 402 of FIG. 21-24 can include any one or more of the above-described direction indicators 450, including any one of the above-described geometric elements 468 and/or any one of the above-described markings 452.

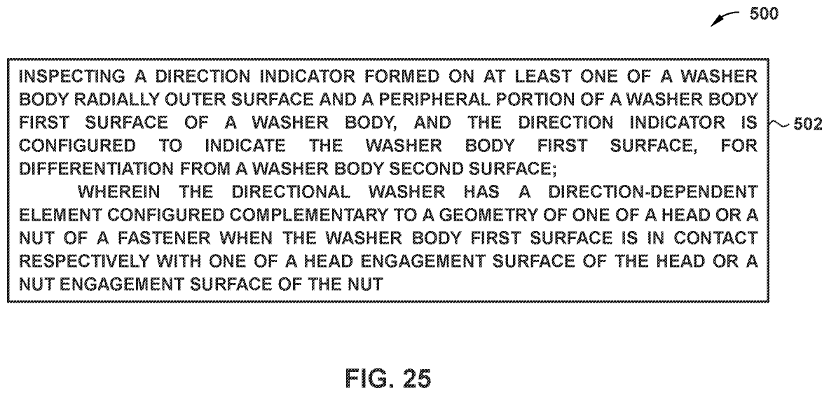

Referring now to FIG. 25, shown is a flowchart of a method 500 of determining the orientation of a directional washer 400. As described above, the directional washer 400 has a washer body 402 and a direction-dependent element 430. The geometry of the direction-dependent element 430 is configured complementary to the geometry of the head 206 or the nut 300 of a fastener system 200 when the washer body first surface 404 is in contact respectively with the head engagement surface 208 or the nut engagement surface 302. The direction-dependent element 430 is at least partially hidden from view by the head 206 or the nut 300 when the nut 300 is completely installed on the fastener 202.

Step 502 of the method 500 comprises inspecting a direction indicator 450 formed on the washer body radially outer surface 410 and/or on the peripheral portion 406 of the washer body first surface 404 of a washer body 402. As described above, the direction indicator 450 is configured to indicate the washer body first surface 404, for differentiation from the washer body second surface 408. Although the direction-dependent element 430 is not visible when the nut 300 is completely installed on the fastener 202, the direction indicator 450 is formed at a location on the washer body 402 that is detectable either visually or tactilely, such as by physically contacting the direction indicator 450 using a human finger. As described below, detection of the direction-dependent element 430 can be performed manually or via an automated system.

In the example of FIGS. 1-20, step 502 of inspecting the direction indicator 450 comprises inspecting the direction indicator 450 of a directional washer 400 having a direction-dependent element 430 configured as a polymeric seal 434 having one or more seal portions extending axially from the washer body first surface 404 and/or washer body second surface 408. For example, in FIGS. 1-20, the seal portions include a seal first portion 436 configured to seal around a shank 212 of the fastener 202, and a seal second portion 438 configured to occupy a void otherwise occurring between the nut counterbore 304 of the nut 300 and the shank 212 of the fastener 202.

Regardless of the configuration of the direction-dependent element 430, step 502 comprises inspecting markings 452 and/or geometric elements 468 formed on the washer body radially outer surface 410 and/or on the peripheral portion 406 of the washer body first surface 404 of a directional washer 400. The process of inspecting markings 452 can include inspecting a color code 454 on the washer body 402 having a first color 456 that is different than a second color 458 adjacent to the first color 456 as shown in FIG. 17 and described above. Alternatively or additionally, the process of inspecting markings 452 can include inspecting indicia 460 in the form of symbols 464 (FIG. 18), reference characters 462 (FIG. 19), and/or a barcode 466 (FIG. 20) on the washer body radially outer surface 410 and/or on the peripheral portion 406 of the washer body first surface 404. As described above, the markings 452 are configured to identify the washer body first surface 404 in a manner that differentiates the washer body first surface 404 from the washer body second surface 408.

The process of inspecting geometric elements 468 can include inspecting a washer body 402 for one or more protrusions 478 extending outwardly from the washer body first surface 404 and/or the washer body radially outer surface 410 as described above with regard to FIGS. 1-7. Alternatively or additionally, inspection of geometric elements 468 can include inspecting depressions 476 (e.g., dimples) formed in the washer body radially outer surface 410 and/or in the washer body first surface 404 as shown in the above-described FIGS. 8-9. Even further, the process of inspecting geometric elements 468 can include inspecting the washer body 402 for a circumferential chamfer 470 or a circumferential radius 472 formed along a juncture of the washer body first surface 404 with the washer body radially outer surface 410 as shown in FIGS. 10-12. In a still further example, the process of inspecting geometric elements 468 on a washer body 402 can include inspecting the washer body 402 for one or more circumferential grooves 474 formed in the washer body first surface 404 and/or in the washer body radially outer surface 410 as shown in FIGS. 13-16.

Any one of the above-described examples for inspecting the direction indicator 450 in step 502 can be applied to directional washers 400 having any one of a variety of different types of direction-dependent elements 430, and is not limited to seal washers 418 having a polymeric seal 434. For example, step 502 of inspecting the direction indicator 450 can be applied to the directional washer 400 of FIGS. 21-24, in which the direction-dependent element 430 comprises a washer countersink 432 formed in the washer opening 414 for accommodating the inside radius 210 under the head 206 of a bolt 203.

Step 502 of inspecting the direction indicator 450 of a directional washer 400 can be performed before or after mounting on a fastener 202. For example, step 502 can comprise inspecting the direction indicator 450 to determine the orientation of a directional washer 400 prior to mounting the directional washer 400 on the shank 212 of a fastener 202. If oriented incorrectly, the directional washer 400 can be reoriented before installing the directional washer 400 on the shank 212. In another example, step 502 can comprise inspecting the direction indicator 450 after mounting a directional washer 400 on the shank 212 of a fastener 202 to determine the orientation of the directional washer 400 relative to the head 206 of the fastener 202 prior to and/or after inserting the fastener 202 into a fastener hole 102 from the front side 104 of a structure 100. In a still further example, step 502 can comprise inspecting the direction indicator 450 after mounting the directional washer 400 on the shank 212 of a fastener 202 protruding from the back side 103 of a structure 100, and after securing (i.e., torquing) the nut 300 onto the threaded portion 216.

As mentioned below, the method 500 can be performed manually or in an automated manner. For example, the method 500 can be manually performed by viewing a fastener installation with the human eye (e.g., aided or unaided) in order to visually determine whether the direction indicators 450 of a directional washer 400 are visible, which indicates that the directional washer 400 is correctly oriented on the fastener 202. Alternatively or additionally, the method 500 can be manually performed by physically contacting the washer body 402 and/or the direction indicators 450 via human touch to determine whether the directional washer 400 is correctly oriented on the fastener 202.

The method 500 can also be performed in an automated manner by using an imaging device 480 (e.g., an automated vision system 482) configured to capture one or more images (not shown) of a directional washer 400 prior to and/or after installation of the directional washer 400 on a fastener 202. The method 500 then includes analyzing the image using a processor (not shown) to determine whether a direction indicator 450 is present on the side of the washer body 402 facing the head 206 or nut 300 of a fastener installation.

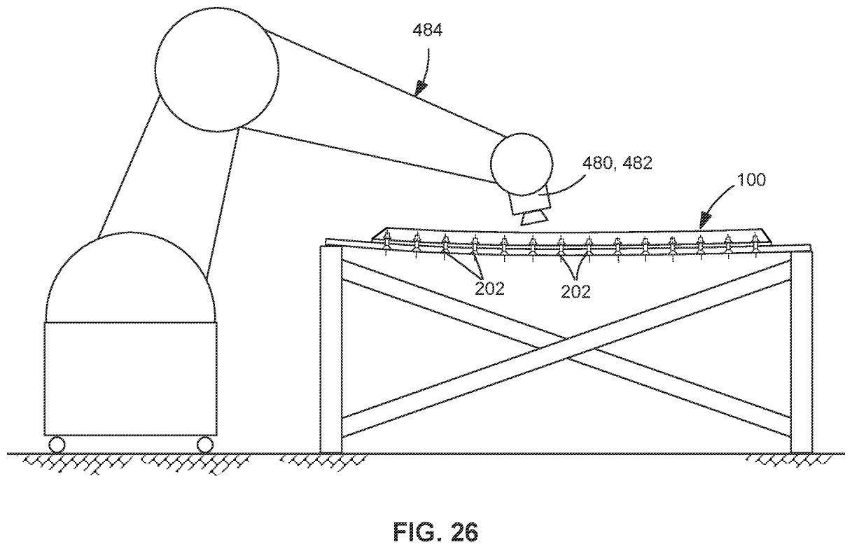

FIG. 26 shows an example of an imaging device 480 mounted on a robotic arm 484. The robotic arm 484 is configured to position the imaging device 480 over one or more of a plurality of fasteners 202 installed in a structure 100. The imaging device 480 can be part of an automated vision system 482 configured to capture images of each fastener installation, and transmit the images to a processor (not shown) configured to determine whether a direction indicator 450 is visible on the washer body 402 of the directional washer 400 mounted on each fastener 202. The processor can also identify fastener installations for which no direction indicators 450 have been detected, indicating that the directional washer 400 is incorrectly oriented at those fastener installations. Although FIG. 26 shows the imaging device 480 supported by a robotic arm 484, the imaging device 480 can be supported by any one of a variety of alternative means including, but not limited to, an overhead gantry. In further examples, the imaging device 480 can be mounted to an automated fastener installation system 486 as described below.

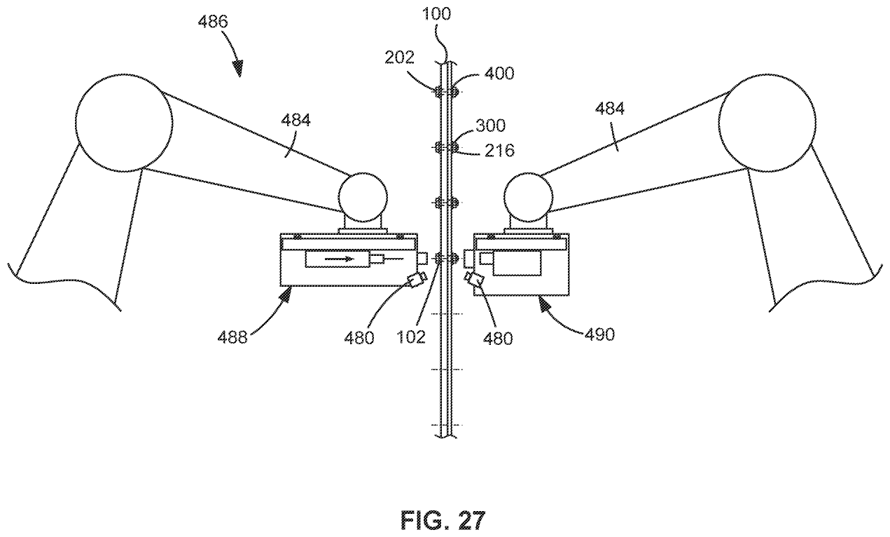

FIG. 27 shows an example of an automated fastener installation system 486 configured to install fasteners 202 in a structure 100. In the example shown, the automated fastener installation system 486 has a front side device 488 and a back side device 490 respectively supported by robotic arms 484 on opposite sides of a structure 100. The front side device 488 and back side device 490 are operated in a coordinated manner for installing fasteners 202 in a structure 100. For example, the front side device 488 can include a plurality of process tools (not shown) associated with hole formation, hole inspection, and fastener installation. In this regard, the front side device 488 drills fastener holes 102 in the structure 100, and inspects the characteristics (e.g., dimensions) of the fastener hole 102 prior to retrieving a fastener 202 from a feed source (not shown), and inserting the fastener 202 into the fastener hole 102, either with or without a directional washer 400 depending on design requirements. Once the fastener 202 is installed in the fastener hole 102, the back side device 490 installs a nut 300 on the threaded portion 216 of the fastener 202, with or without a directional washer 400.

In FIG. 27, an imaging device 480 is mounted to each of the front side device 488 and the back side device 490. The imaging devices 480 facilitate the inspection of fastener installations using the direction indicators 450 to determine the orientation of the directional washers 400. The inspection of the orientation of the directional washer 400 in FIG. 27 can be similar to the process described above using the imaging device 480 of FIG. 26. If a directional washer 400 is found to be incorrectly oriented, the front side device 488 and the back side device 490 can be operated in a coordinated manner to remove the fastener 202 from the fastener hole 102, and reinstall the fastener 202 with the directional washer 400 in the correct orientation.

The imaging devices 480 can also inspect the orientation of directional washers 400 prior to the installation of a fastener 202 into the structure 100. For example, the imaging device 480 on the front side device 488 can capture an image of a directional washer 400 before or after mounting the directional washer 400 on the shank 212 of a fastener 202, but prior to insertion of the fastener 202 in the fastener hole 102. If analysis of the image (e.g., via a processor) determines that the directional washer 400 is oriented incorrectly, the front side device 488 can reorient the directional washer 400 prior to mounting the directional washer 400 on the fastener 202. If the directional washer 400 is already mounted on the fastener 202, the front side device 488 can remove the directional washer 400 from the shank 212, and remount it in the correction orientation prior to inserting the fastener 202 in the fastener hole 102. Advantageously, the ability to inspect the orientation of a directional washer 400 prior to or after installation in a structure 100 can significantly reduce production time be reducing or eliminating the need for time-consuming rework of fastener installations.

Many modifications and other versions and examples of the disclosure will come to mind to one skilled in the art to which this disclosure pertains having the benefit of the teachings presented in the foregoing descriptions and the associated drawings. The versions and examples described herein are meant to be illustrative and are not intended to be limiting or exhaustive. Although specific terms are employed herein, they are used in a generic and descriptive sense only and not for purposes of limitation. Functionally equivalent methods and apparatuses within the scope of the disclosure, in addition to those enumerated herein, are possible from the foregoing descriptions. Such modifications and variations are intended to fall within the scope of the appended claims. The present disclosure is to be limited only by the terms of the appended claims, along with the full scope of equivalents to which such claims are entitled.

What is claimed is:

1. A directional washer for a fastener, comprising:
a washer body having a washer body first surface, a washer body second surface, and a washer body radially outer surface;
a direction-dependent element associated with the washer body and having a geometry configured complementary to one of a head or a nut of the fastener when the washer body first surface is in contact respectively with one of a head engagement surface of the head or a nut engagement surface of the nut; and
a direction indicator formed on at least one of the washer body radially outer surface and a peripheral portion of the washer body first surface and configured to identify the washer body first surface for differentiation from the washer body second surface.

2. The directional washer of claim 1, wherein the direction indicator comprises at least one of the following:
one or more markings; and
one or more geometric elements.

3. The directional washer of claim 2, wherein the one or more markings comprise at least one of the following:
a color code using a first color that is different than a second color adjacent to the first color; and
indicia in the form of at least one of reference characters, symbols, and a barcode.

4. The directional washer of claim 3, wherein:
the one or more markings are comprised of at least one of ink, paint, laser marking, and electrochemical etching.

5. The directional washer of claim 2, wherein the one or more geometric elements comprise at least one of the following:
a circumferential chamfer or a circumferential radius formed along a juncture of the washer body first surface with the washer body radially outer surface;
a circumferential groove formed in at least one of the washer body first surface and the washer body radially outer surface;
one or more depressions formed in at least one of the washer body first surface and the washer body radially outer surface; and
one or more protrusions extending outwardly from at least one of the washer body first surface and the washer body radially outer surface.

6. The directional washer of claim 1, wherein the direction-dependent element comprises:
a polymeric seal having one or more seal portions extending axially from at least one of the washer body first surface and the washer body second surface.

7. The directional washer of claim 6, wherein:
the washer body has a washer body radially inner surface; and
the one or more seal portions comprise:
a seal first portion coupled to the washer body along the washer body radially inner surface and configured to seal around a shank of the fastener; and
a seal second portion extending axially from the seal first portion in a direction away from the washer body first surface and configured to seal inside a nut counterbore of the nut when secured on a threaded portion of the fastener installed in a fastener hole in a structure.

8. The directional washer of claim 1, further comprising:
a dielectric coating the washer body.

9. A fastener system, comprising:
a fastener having a head and a shank insertable into a fastener hole in a structure;
a directional washer mountable on the fastener, and comprising:
a washer body having a washer body first surface, a washer body second surface, and a washer body radially outer surface;
a direction-dependent element associated with the washer body and configured complementary to one of the head or a nut of the fastener when the washer body first surface is in contact respectively with one of a head engagement surface of the head or a nut engagement surface of the nut; and
a direction indicator formed on at least one of the washer body radially outer surface and a peripheral portion of the washer body first surface at a location that is visible when the fastener is installed in the fastener hole, and the direction indicator is configured to identify the washer body first surface for differentiation from the washer body second surface.

10. The fastener system of claim 9, wherein the direction indicator comprises at least one of the following:
one or more markings; and
one or more geometric elements.

11. The fastener system of claim 9, wherein:
the nut is threadably engageable to a threaded portion of the shank; and
the direction-dependent element is a polymeric seal having one or more seal portions extending axially from at least one of the washer body first surface and the washer body second surface.

12. The fastener system of claim 11, wherein:
the washer body has a washer body radially inner surface; and
the one or more seal portions comprise:
a seal first portion coupled to the washer body along the washer body radially inner surface and configured to seal around a shank of the fastener; and
a seal second portion extending axially from the seal first portion in a direction away from the washer body first surface and configured to seal inside a nut counterbore of the nut when secured on a threaded portion of the fastener installed in the fastener hole of the structure.

13. A method of determining an orientation of a directional washer, comprising:
inspecting a direction indicator formed on at least one of a washer body radially outer surface and a peripheral portion of a washer body first surface of a washer body, and the direction indicator is configured to indicate the washer body first surface for differentiation from a washer body second surface; and
wherein the directional washer has a direction-dependent element configured complementary to a geometry of one of a head or a nut of a fastener when the washer body first surface is in contact respectively with one of a head engagement surface of the head or a nut engagement surface of the nut.

14. The method of claim 13, wherein inspecting the direction indicator comprises:
inspecting at least one of markings and geometric elements formed on at least one of the washer body radially outer surface and the peripheral portion of the washer body first surface.

15. The method of claim 14, wherein inspecting at least one of markings and geometric elements comprises:
inspecting markings in the form of a color code on the washer body and/or indicia in the form of at least one of reference characters, symbols, and a barcode;
inspecting geometric elements on the washer body in the form of at least one of the following:
a circumferential chamfer or a circumferential radius formed along a juncture of the washer body first surface with the washer body radially outer surface;
a circumferential groove formed in at least one of the washer body first surface and the washer body radially outer surface;
one or more depressions formed in at least one of the washer body first surface and the washer body radially outer surface; and
one or more protrusions extending outwardly from at least one of the washer body first surface and the washer body radially outer surface.

16. The method of claim 13, wherein inspecting the direction indicator comprises at least one of the following:
inspecting the direction indicator to determine an orientation of the directional washer prior to mounting on a shank of the fastener;
inspecting the direction indicator after mounting the directional washer on the shank of the fastener to thereby determine the orientation of the directional washer relative to the head of the fastener prior to and/or after inserting the fastener in a fastener hole from a front side of a structure; and
inspecting the direction indicator after mounting the directional washer on the shank protruding from a back side of the structure, and after threading the nut onto a threaded portion of the shank, to thereby determine the orientation of the directional washer relative to the nut.

17. The method of claim 13, wherein inspecting the direction indicator comprises:
capturing, using an imaging device, an image of the directional washer prior to and/or after installation on the fastener; and
analyzing the image to determine an orientation of the directional washer.

18. The method of claim 17, further comprising:
supporting the imaging device using one of a robotic arm or an automated fastener installation system.

19. The method of claim 13, wherein inspecting the direction indicator comprises:
inspecting the direction indicator formed on a washer body in which the direction-dependent element comprises a polymeric seal having one or more seal portions extending axially from at least one of the washer body first surface and the washer body second surface.

20. The method of claim 19, wherein:
the washer body has a washer body radially inner surface; and
the one or more seal portions comprise:
a seal first portion coupled to the washer body along the washer body radially inner surface and configured to seal around a shank of the fastener; and
a seal second portion extending axially from the seal first portion in a direction away from the washer body first surface and configured to seal inside a nut counterbore of the nut when secured on a threaded portion of the fastener installed in a fastener hole of a structure.
